(19) United States
(12) Patent Application Publication
(10) Pub. No.: US 2011/0079170 A1
(43) Pub. Date: Apr. 7, 2011

(54) SECURITY SYSTEM FOR STORING FIREARMS

(76) Inventor: Abdullah Ali Al-Mutairi, Alfirdous (KW)

(21) Appl. No.: 12/571,566

(22) Filed: Oct. 1, 2009

(51) Int. Cl. E05G 1/00; E05G 1/06; H04N 5/225

(52) U.S. Cl. 109/23; 348/143; 340/568.1; 348/E05.024

(57) ABSTRACT

A system for monitoring and controlling the consumption of electrical energy and for warning a consumer of the status of their use including subsystem that produces there warning levels. The first warning is a visual signal while the second signal is an audio signal. The third signal is an audio signal louder than the second signal to warn a consumer that their supply of power will be interrupted in a given amount of time. The third signal also includes a timer to indicate that the power will be discontinued within a number of minutes. The system also includes an internal electric current restoration unit for reconnecting the supply of power when a preselected period of time has passed or power has been reduced to a preselected level before being interrupted.

### BACKGROUND FOR THE INVENTION

1. Field of the Invention

The present invention relates to a centralized security system for storing firearms and more particularly to a dual lock security system with a plurality of separately accessible storage units.

2. Background of the Invention

Security systems for storing firearms and other weapons are well known and have been available for many years. For example, a need to safely secure firearms has lead to a number of specialty products such as trigger locks, gun safes, gun drawers, gun cases, gun cables, barrel locks, locking gun racks, fingerprint identifiers, trigger pins and other devices. Such devices reduce the risks associated with ownership of one or more firearms. However, many such devices fail to detect unauthorized access to a firearm and fail to alert an outside authority when a weapon is removed from a secure facility.

One relatively recent approach to a system for storing firearms is disclosed in a U.S. Pat. No. 6,791,451 of Muise et al. As disclosed, a system for monitoring the storage security of firearms and through a microprocessor radio-controlled transceiver embedded within the firearm enables detection of theft or remova., and then radio-tracking of the stolen firearm by the proper authorities and also for providing automatic warning to schools or other public buildings of an intruder bearing a stolen firearm.

A more recent approach to an apparatus for securing firearms is disclosed in a U.S. Pat. No. 7,116,224 of Mickler. The Mickler patent discloses a portable case including a lock, sensors and structure to support an article being protected. The case is adapted to become part of a pre-existing facility securing system and configured to receive any of several connectivity elements that are compatible with at least one of the security systems. For example, wireless transmitters that are compatible with different alarm systems may be connected. The case provides an efficient way of retrofitting an existing facility alarm or security system to protect a firearm.

Notwithstanding the above, it is presently believed that there is a need and a possible commercial market for an improved security system for firearms in accordance with the present invention. There should be a market because such systems are capable of securely storing firearms of multiple individuals with a dual lock system so that each individual that stores a firearm in the system has a key to gain access to the system. The individual then uses a second lock mechanism such as an electronic lock and his or her personal code to gain access to the separately accessible storage unit which contains one or more of their firearms.

The system also includes an alarm that warns a security office that someone has obtained or is trying to obtain access to the facility. Cameras are also provided to send a photo of the individual or individuals who have gained access or are attempting to gain access to the facility. The camera also provides a record of each unit accessed before and after each access as well as the date and time of the access.

As a result, the system provides a centralized repository for firearms of a number of different individuals and each individuals firearms are only accessible to the individual owner.

### BRIEF SUMMARY OF THE INVENTION

In essence the present invention contemplates a security system for storing firearms that include a reinforced metal cabinet and a waterproof seal for keeping water out of the cabinet. Insulation is also provided for protecting the contents of the cabinet from fire and excessive heat for a limited period of time. The system also includes air conditioning means as for example an exhaust fan and a fan and filter for drawing filtered air into the cabinet. A dehumidifier is provided for removing water from the air together with means such as a heat pump for heating and or cooling the air to maintain a relatively constant temperature within the cabinet. The system further comprises a plurality of separately accessible storage units disposed within the cabinet. Each of the storage units are designed to contain one or more firearms and may be provided in the form of a series of drawers mounted on a rotatable wheel or carousel for movement to and from an access area. An important feature of the present invention resides in a dual lock arrangement wherein a mechanically operated lock and key are provided for access to the system while an electronic locking mechanism activatible by a preselected access code provides access to one of the separately accessible storage units. For example, a keyboard may be used. In addition, the system in accordance with the present invention includes an access area and a mechanism for moving one of the separately accessible storage units into the access area in response to an entry of its specific access code. The system also includes means for connecting the system to a source of electricity and a battery as a backup source of power. In addition, the system includes a camera disposed within the cabinet for recording and storing an image of each of the separately accessed storage units after each access to the storage unit and preferably with the time and date of such access. Further, the system includes a fire alarm which may be connected to one or more remote locations and a remotely accessible monitor.

A centralized system in accordance with the present invention will now be described in connection with the following drawings.

### DESCRIPTION OF THE DRAWINGS

FIG. 1 is a perspective view of an alarm ready protective case according to the prior art;

FIG. 2 is a schematic illustration of a centralized security system in accordance with the present invention;

FIG. 3 is a schematic illustration of an access area and mechanism for bringing a firearm from a separately accessible storage unit into registering with an access area pursuant to entry of an individual's private code; and

FIG. 4 is a flow chart indicating use of a centralized security system in accordance with the present invention.

### DESCRIPTION OF THE PREFERRED EMBODIMENTS OF THE INVENTION

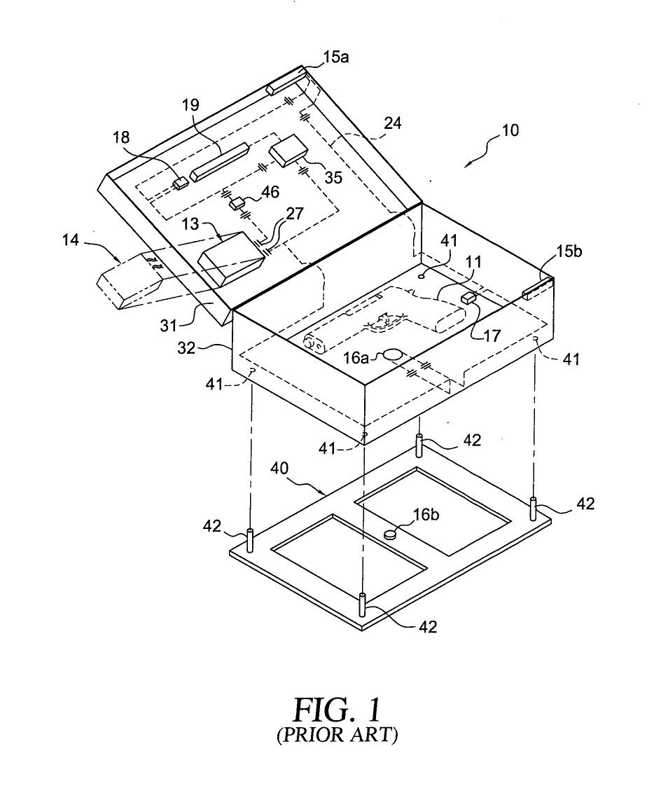

A prior art apparatus for securing a firearm is shown in FIG. 1. As shown, a gun case 10 is equipped with a lock or locking mechanism 19 and a variety of alarm condition sensors 15-18. The lock and the sensors can be active devices that use electrical energy, for example as supplied by batteries. Advantages are realized instead, however, by the use of a passive mechanical locking mechanism and mechanical switch equipped sensors that do not require a power source. Switch 15 (15a, 15b) is provided to detect the opening of the box. Switch 16 is provided to detect the removal of the box from its resting place. Switch 18 is provided to detect tampering with the lock 19, while switch 17 represents any of a number of other sensors that may be provided to detect vibrations, motion or other conditions.

A wireless transmitter 14 is used to integrate this case 10 with an alarm system 12. Transmitters 14 are typically provided as accessories by the vendors of security systems 12. These transmitters 14 are equipped with electronics for sending an alarm signal to a receiver 21 which triggers the alarm system, in response to a received signal from the transmitter 14, as it does with any of several other perimeter intrusions or motion detection sensors 22 that may be hard wired or otherwise connected to the system 12. Transmitters 14 are typically provided with their own internal battery powered power supply. Terminals my also be provided for direct wiring of the case to a security system or other external device.

The case 10 may be equipped with sensors 15-18 that are designed to detect access, either authorized, unauthorized or both, to the case 10, movement of the case 10, also either authorized, unauthorized or both, and tampering with the case 10 or the lock 19. The case 10 may also be equipped with a panic button or to otherwise signal duress or other emergency situation. Wireless transmitters 14 may be selected that respond differently to different alarm conditions, and the system 12 may be provided with programming or other logic to recognize these different conditions and respond accordingly.

The case 10 is furnished in an “alarm ready” state so that it can be used with any of a plurality of systems 12 upon installation of a system compatible transmitter 14. When fitted with a transmitter 14, the case 10 operates as a wireless ancillary device with any such security system 12. A portion of the interior of the case 10 is equipped with the structure 13 that is configured as a transmitter holder or to otherwise receive a transmitter. Such structure is dimensioned to accommodate wireless alarm condition transmitters 14 of types available from the manufacturers of, or compatible with, all of the security systems 12 with which the case 10 is intended to be useful. Wiring 24 for the internal alarm sensors 15-18 of the case 10 terminates in the transmitter holder. The “alarm ready” case 10 is fully functional as a security device when purchased, and only requires the addition of a transmitter 14 or other connectivity hardware to integrate the case 10 with the security system 12. Further details and prior art are set forth in U.S. Pat. No. 7,116,224 of Mickler which is incorporated herein in its entirety by reference.

The gun case 10 shown in FIG. 1 may be incorporated in the system in accordance with the present invention as for example by being placed in or becoming a part of a separately accessible storage unit. It is also contemplated that one or more figures of the prior art may be incorporated in or become a part of the unique combination of elements as included in one embodiment of the present invention.

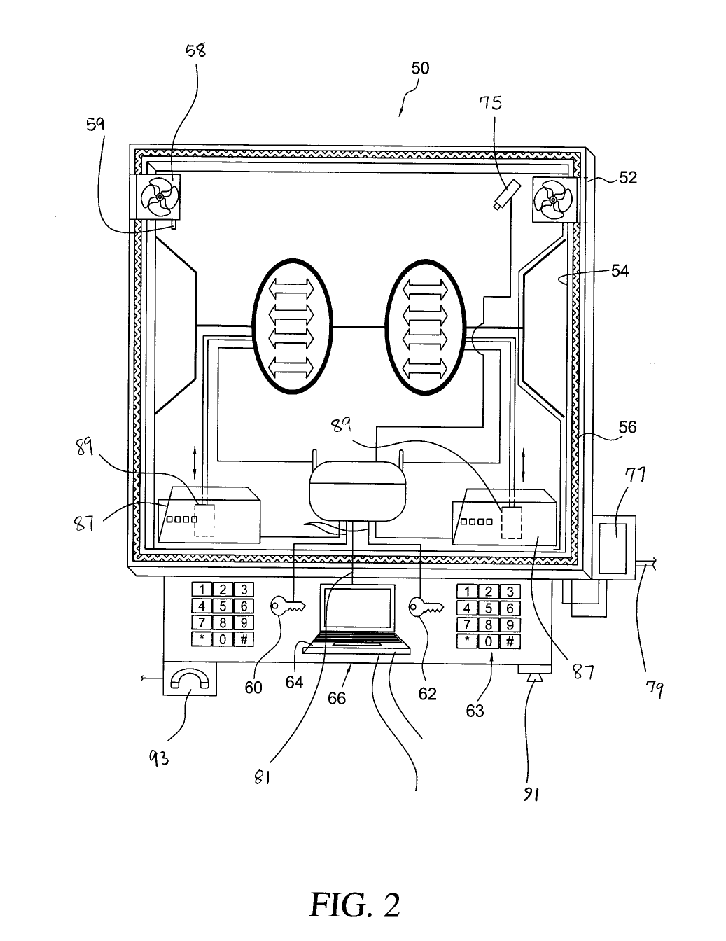

Referring now to FIG. 2, a security system 50 for storing firearms of one or more individuals includes a reinforced metal cabinet 52 such as steel, aluminum or the like. The cabinet includes a waterproof seal 54 that also excludes dust or other airborne contaminants. A layer 56 of insulation material provides protection against fire and excessive heat in a conventional manner for a limited period of time. A dehumidifier 58 is also provided for removing moisture from the air.

An important feature of the present invention resides in a dual locking arrangement that allows a number of individuals to store their firearms in a single secure location. In this arrangement, the first lock 62 (shown schematically as a key) is a mechanical or key opened lock such as a door lock to a secure facility or area. In this case a key 60 allows an individual to enter the system. It should be recognized that other types of keys such as an electronic or card key can be used.

The second lock 64 is effectively stored in a computer 66 and operated by a first keyboard 63. The second lock is electronically activated by a code known only to the individual that owns a specific weapon that is stored in the system in a specific compartment.

In a preferred embodiment of the invention a number of individuals store their firearms or weapons in a centralized secure facility and wherein the weapons are safely stored, protected against fire, heat and moisture and are separately accessible only by the individual owners. A process for securely placing one's firearms and retrieving them includes the following steps. In a first step 80 an individual brings his or her weapons to a secure facility as for example an armory for safe keeping. In a second step 82, the individual pays a fee and fills out a form indicating their name, address and identification of the firearm and a pin number. The individual is then given a key to the facility and an electronic code for gaining access to the firearm in step 84. The code may be a combination of numbers, letters and the like.

The individual uses this pin number as authorization to gain access to the electronic system in step 86. The individual then deposits their weapon or weapons in the separately accessible unit that can be found in the access area in step 86 and stores the unit including the firearm in step 88. The unit may be returned to storage by pressing a “STORE” button or the like. Another important factor in the present invention resides in a camera which photographs the contents of the storage unit in step 90 to record exactly what has been sent to storage.

When the individual wants access to his or her firearm they use the key to gain access to the area in step 92, enter their pin number or password and uses the electronic key code in step 94 so that their storage unit will be returned to the access area in step 95. After claiming the weapon, the separately accessible storage unit is returned to storage in step 96.

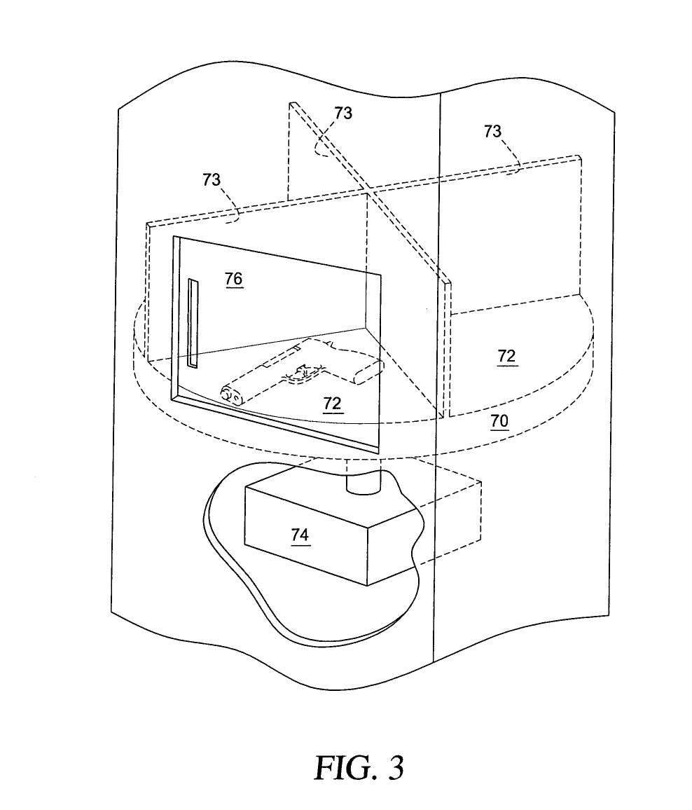

FIG. 3 is a schematic illustration of a further embodiment of the invention wherein a secure compartment such as a secure drawer is fixed to or picked up by a carousel or wheel to move the secure compartment into an access area in response to entry of a secure code. As illustrated in FIG. 3, a generally horizontal wheel or turn table 70 is divided into four compartments 72 by walls 73 and constructed and arranged to rotate about a base 74. As shown, the turn table 70 is constructed and arranged to bring a compartment into register with a door 76 in response to an appropriate code to thereby provide an owner of a firearm with access to their weapons. Other compartments will be provided and accessible by other owners by submitting their personal code.

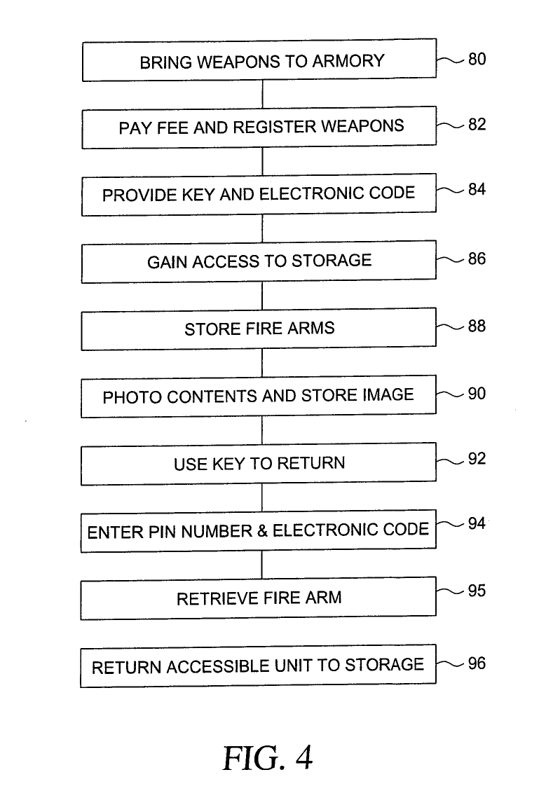

The use of a centralized security system in accordance with the present invention will now be described with reference to FIG. 4. In a first step, an individual brings his weapons to an armory or other high security facility in step 80 and pays a fee to register and store the firearms in step 82. The fee may vary based on the number and type of firearms stored and/or perhaps depending on the level of security required. Upon payment of the fee, the individual is provided a key or access code that allows the individual to obtain access to a secure area where the individual can obtain access to or store his weapons in step 84. Using the key, the individual in step 86 gains access to an inner secure area and stores his/her weapons in a secure container in step 88. In step 90, the open container is photographed and the image as well as the container or compartment is returned to a high security area where they are inaccessible without use of a pin number, photo-Id or the like. Then, when an individual wishes to take possession of the weapon, he/she returns to the facility and uses the key to obtain access to the access area in step 92 and enters his pin number or electronic code in step 94. This code will automatically bring the individual's secure container to an access door or the like. It is also contemplated that a scanner for scanning the individual's retina of the eye and/or fingerprint may be used in place of a pin number or electronic code for a higher level of security. In step 95 the individual retrieves their weapon and returns the accessible unit to storage in step 96.

An important aspect of the present invention resides in an automatic imaging system that records and stores an image of what is in the individual container each time the container is sent to storage. The imaging system may also include an image of the individual, date and time when the individual accesses their container.

It is also contemplated that each facility will have multiple access areas to accommodate more than one individual at a time and that each entry point is adjacent to one access area.

While the invention has been described in connection with its preferred embodiments it should be recognized that changes and modifications may be made therein without departing from the scope of the appended claims.

1. (canceled)

2. A centralized security system for storing one or more firearms according to claim 10, further comprising a means for monitoring said centralized security system from a remote location.

3. A centralized security system for storing one or more firearms according to claim 10, wherein said reinforced metal enclosure is made of aluminum.

4. (canceled)

5. (canceled)

6. (canceled)

7. (canceled)

8. A centralized security system for storing one or more firearms according to claim 10, wherein said electronic locking means includes a manual operatable programmable key pad.

9. (canceled)

10. A centralized security system for storing one or more firearm, comprising:
a reinforced metal enclosure including sealing means for preventing water from entering said reinforced metal enclosure and protecting contents of said reinforced metal enclosure from fire and excess heat;
an air conditioning, filter, and dehumidifier means operably disposed within said reinforced metal enclosure for removing dust and moisture from the air entering said reinforced metal enclosure;
means for controlling the temperature within said reinforced metal enclosure;
a plurality of separately accessible storage units moveably disposed within said reinforced metal enclosure wherein each of said plurality of separately accessible storage units is dimensioned and configured to securely enclose and confine one firearm;
a wheel rotatably supporting said plurality of separately accessible storage units;
a mechanical key operated lock and a key for obtaining access to said reinforced metal enclosure;
an access area, and means for moving said plurality of separately accessible storage units into said access area;
an electronic locking means activateable by a special code for rotating said wheel to bring one of said plurality of separately accessible storage units into alignment with said access area allowing a user to gain access to said respective one of said plurality of separately accessible storage units in response to entry of specific access code;
a battery means and means for connecting said centralized security system to a source of electricity for powering said centralized security system;
a camera disposed within said reinforced metal enclosure for recording and storing an image of each of said user accessing inside of said reinforced metal enclosure and said plurality of separately accessible storage units after each access;
a alarm system activateable as a result of fire or unlawful intrusion of said centralized security system; and,
a telephone means for transmitting the alarm alert to a remote location.
